(19) United States
(12) Patent Application Publication
(10) Pub. No.: US 2011/0239141 A1
(43) Pub. Date: Sep. 29, 2011

(54) METHOD, APPARATUS AND SYSTEM FOR IDENTIFYING GUI ELEMENT

(75) Inventors: Lian WANG, Beijing (CN); Xin MENG, Beijing (CN); Cailiang SONG, Beijing (CN); Huifeng LIU, Beijing (CN); Jingwei SHI, Beijing (CN); Xiaowei LIU, Beijing (CN)

(73) Assignee: NEC (CHINA) CO., LTD., Beijing (CN)

(21) Appl. No.: 13/012,493

(22) Filed: Jan. 24, 2011

(30) Foreign Application Priority Data
Mar. 29, 2010 (CN) 201010137015.4

(51) Int. Cl. G06F 3/048

(52) U.S. Cl. 715/763

(57) ABSTRACT

Here is disclosed a method, an apparatus and a system for identifying a Graphical User Interface (GUI) element. According to an aspect of the present invention, a method of generating a GUI element identification information comprises: displaying a GUI which includes a target GUI element; analyzing the displayed GUI, to acquire attribute information for the target GUI element; acquiring extra information, other than the attribute information, related to the target GUI element; and processing the attribute information and the extra information to generate the identification information for the target GUI element.

### FIELD OF INVENTION

The present invention relates to the field of computer applications, and particularly, relates to a Graphical User Interface (GUI) element identification method for identifying a target GUI element on a GUI more accurately, as well as an apparatus and a system using the same.

### DESCRIPTION OF PRIOR ART

Currently, there are a great amount of Graphical User Interfaces (GUIs) in computer applications. For various purposes, GUI element identification becomes an important research subject. However, some of GUI elements are difficult to be identified correctly due to complexity of the applications themselves and poor technical means. Thus, many problems may be caused in practices.

For example, it is often required in a practical application that a non-WEB application, i.e. a local application, may be migrated to a WEB-based application by the migration technique, in which a lot of identification of GUI elements for the local application is involved. A consistency between the two applications before and after migration in terms of GUI elements must be guaranteed. Otherwise, a consistency between the two applications before and after migration in terms of views and functionalities cannot be implemented. The inconsistency may cause failure of the migration and thus a disastrous result.

Currently, a GUI element is generally identified with attribute information of the GUI element. For example, this attribute information may be XML descriptions of the GUI element, i.e., XPath information of the GUI element. Reference 1 (CN101369249A) discloses a method of identifying a GUI element by means of XPath. Hereinafter, the XPath based identification method will be described with reference to FIGS. 1 and 2.

FIG. 1 shows a GUI 1000 of an exemplary local application. Referring to FIG. 1, the GUI 1000 comprises a GUI element 1001. When a user clicks “OK” key on the GUI element 1001, a GUI element 1002 will be popped up. For example, XPath information of the GUI element 1002 should be acquired firstly, in order to identify the GUI element 1002 based on XPath in practices.

For this purpose, training may be performed firstly. During the training, all user interface (UI) information on the current GUI of the local application may be acquired by, e.g., a UI dump unit. In the example as shown in FIG. 1, all the UI information on the GUI 1000 may be acquired and stored in XML format. FIG. 2 shows the stored information on the GUI 1000 in XML format. Then, the information may be analyzed to obtain the XPath information of the GUI element 1002, as shown in the block of FIG. 2. The XPath information for the GUI element 1002 may be recorded as

“/element[@text=‘Form1’]/children/element[@text=‘Form2’]/children/
element[@text=‘Return’]”.

During running, all UI information of a current GUI may be acquired by the UI dump unit. Here, it is assumed that the GUI presented during the running is still the GUI 1000 as shown in FIG. 1. Since the same GUI 1000 is exemplified, the acquired UI information is also that illustrated in FIG. 2. Then, the recorded XPath information is searched for an item which matches an information item corresponding to some GUI element, such as the information item in the block as illustrated in FIG. 2, in the UI information. Here, it may be found by the search that the XPath information for the GUI element 1002 recorded as described above matches the information in the block. Thus, it can be determined that the GUI element corresponding to the information in the block is the GUI element 1002.

Of course, respective XPath information for a plurality of target elements may be recorded during the training. Then, respective GUI elements in a current GUI may be identified respectively based on the recorded XPath information during the running.

However, generally some GUI element may not be uniquely identified by means of XPath, especially when same items exist in the XPath information as recorded for a plurality of GUI elements. FIG. 3 shows another exemplary application. With reference to FIG. 3, in this application, when in a GUI element 3001 an “OK” key is clicked without checking a checkbox (as illustrated by an arrow “1”), a GUI element 3002 will be popped up. Then, if a “Return” key in the GUI element 3002 is clicked (as illustrated by an arrow “2”), this will results in return back to the GUI element 3001 in which the checkbox is not checked. On the other hand, when in the GUI element 3001 the “OK” key is clicked with the checkbox checked (as illustrated by an arrow “3”), a GUI element 3003 will be popped up. Then, if a “Return” key in the GUI element 3003 is clicked (as illustrated by an arrow “4”), this will result return back to the GUI element 3001′ in which the checkbox is checked.

As seen from above, the GUI elements 3002 and 3003 are different. However, according to the XPath method, both of them are described as:

“/element[@text=‘Form1’]/children/element[@text=‘Form2’]/children/
element[@text=‘Return’]”.

Thus, the GUI elements 3002 and 3003 can not be distinguished correctly by means of XPath.

Hence, there is a need for an improved element identification method, as well as an apparatus and a system using the same, to identify GUI elements correctly.

### SUMMARY OF THE INVENTION

In view of the above, an object of the present invention is to provide an enhanced Graphical User Interface (GUI) element identification method, as well as an apparatus and a system using the same. It is possible to significantly improve the accuracy in identifying GUI elements by means of the identification method, the apparatus and the system, so as to correctly identify the GUI elements.

According to an aspect of the present invention, there is provided a method of generating GUI element identification information, comprising: displaying a GUI which includes a target GUI element; analyzing the displayed GUI, to acquire attribute information for the target GUI element; acquiring extra information, other than the attribute information, related to the target GUI element; and processing the attribute information and the extra information to generate the identification information for the target GUI element.

Preferably, the attribute information may comprise XPath information, and acquiring the attribute information may comprise: acquiring information, which is in XML format, on all elements within the GUI; and analyzing the element information in XML format to acquire the XPath information for the target GUI element.

Preferably, the extra information may comprise information on historical event(s) causing the target GUI element to occur, and acquiring the extra information may comprise: recording the historical event(s) causing the target GUI element to occur; and analyzing the historical event(s) to transform it/them into occurring condition(s) for the target GUI element, wherein the occurring condition(s) become(s) the information on historical event(s) for the target GUI element.

Preferably, the extra information may comprise system state information.

According to another aspect of the present invention, there is provided a method of identifying a GUI element to be identified based on GUI element identification information, the GUI element identification information comprising attribute information and extra information for respective GUI element(s). The method comprises: displaying a GUI which includes the GUI element to be identified; analyzing the displayed GUI, to acquire attribute information for the GUI element to be identified; acquiring extra information, other than the attribute information, related to the GUI element to be identified; and searching the GUI element identification information for an information item with attribute information matching the acquired attribute information for the GUI element to be identified and also with extra information matching the acquired extra information related to the GUI element to be identified.

Preferably, the extra information may comprise historical event information and/or system state information.

According to still another aspect of the present invention, there is provided an apparatus of generating GUI element identification information, comprising: a display device adapted to display a GUI which includes a target GUI element; an is attribute information acquiring unit adapted to analyze the displayed GUI to acquire attribute information for the target GUI element; an extra information acquiring unit adapted to acquire extra information, other than the attribute information, related to the target GUI element; and an identification information generating unit adapted to process the attribute information acquired by the attribute information acquiring unit and the extra information acquired by the extra information acquiring unit to generate the identification information for the target GUI element.

Preferably, the attribute information may comprise XPath information, and the attribute information acquiring unit may comprise: an UI dump unit adapted to acquire information, which is in XML format, on all elements within the GUI; and an attribute information generating unit adapted to analyze the element information in XML format acquired by the UI dump unit to acquire the XPath information for the target GUI element.

Preferably, the extra information may comprise information on historical event(s) causing the target GUI element to occur, and the extra information acquiring unit may comprise: an event recording unit adapted to record the historical event(s) causing the target GUI element to occur; a target GUI element determining unit adapted to determine whether the target GUI occurs on the GUI or not, and to send the determination result to the event recording unit; and an extra information generating unit adapted to generate the extra information comprising the information on the historical event(s) based on the historical event(s) for the target GUI element recorded by the event recording unit.

According to yet another aspect of the present invention, there is provided an apparatus of identifying a GUI element, comprising: storage means adapted to store GUI element identification information comprising attribute information and extra information for respective GUI element(s); a display device adapted to display a GUI which includes the GUI element to be identified; an attribute information acquiring unit adapted to analyze the displayed GUI to acquire attribute information for the GUI element to be identified; an extra information acquiring unit adapted to acquire extra information, other than the attribute information, related to the GUI element to be identified; and an identifying unit adapted to identify the GUI element to be identified based on the attribute information acquired by the attribute information acquiring unit and the extra information acquired by the extra information acquiring unit as well as the GUI element identification information stored in the storage means.

According to yet another aspect of the present invention, there is provided a GUI element identification system, comprising the apparatus of generating GUI element identification information according to the present invention and the GUI element identifying apparatus according to the present invention, wherein the storage means stores the GUI element identification information generated by the apparatus of generating GUI element identification information.

Preferably, the attribute information acquiring unit included in the apparatus of generating GUI element identification information and the attribute information acquiring unit included in the GUI element identifying apparatus are made by a same unit, and the extra information acquiring unit included in the apparatus of generating GUI element identification information and the extra information acquiring unit included in the GUI element identifying apparatus are made by a same unit.

According to the present invention, due to the introduction of the extra information into the identification of the elements, it is possible to overcome the defect that in some cases some GUI elements cannot be distinguished just based on the attribute information, and thus it is possible to greatly improve the accuracy in identifying GUI elements.

### BRIEF DESCRIPTION OF THE DRAWINGS

The above and other objects, features and advantages of the present invention will be more apparent by the following descriptions of embodiments of the present invention with reference to the drawings, in which:

FIG. 1 shows a GUI of an exemplary local application according to the prior art;

FIG. 2 shows UI information of GUI elements in the GUI as illustrated in FIG. 1;

FIG. 3 shows a schematic transition diagram of a GUI in another exemplary local application according to the prior art;

FIG. 4 shows a method of generating GUI element identification information according to an embodiment of the present invention;

FIG. 5 shows a schematic transition diagram of a GUI in an exemplary local application according to an embodiment of the present invention;

FIG. 6 shows a schematic diagram of exemplary identification information according to an embodiment of the present invention;

FIG. 7 shows a method of identifying a GUI element according to an embodiment of the present invention;

FIG. 8 shows a schematic diagram of an apparatus of generating GUI element identification information according to an embodiment of the present invention;

FIG. 9 shows a schematic structure diagram of an XPath information acquiring unit according to an embodiment of the present invention;

FIG. 10 shows a schematic structure diagram of an extra information acquiring unit according to an embodiment of the present invention; and

FIG. 11 shows an apparatus of identifying a GUI element according to an embodiment of the present invention.

### DETAILED DESCRIPTION OF PREFERRED EMBODIMENTS

Hereinafter, the present invention will be described in detail by referring to the embodiments as shown in the drawings. However, it should be understood that the descriptions are only Illustrative and are not intended to limit the present invention. Further, in the following, descriptions on well-known structures and techniques are omitted so as not to obscuring concepts of the present invention.

Some forms of GUIs are shown in the drawings as examples. However, it should be noted that these GUIs are only drawn illustratively and in practices there may be various GUIs in various forms. Further, some process steps and processing modules are shown in the drawings. However, some of these process steps/processing modules may be combined into a single step/module, or a single one of these process steps/processing modules may be divided into several sub-steps/sub-modules. It should be appreciated that these process steps/processing modules may be implemented in hardware, software, firmware or combinations thereof.

According to the present invention, identification information which is enhanced over the attribute information in the prior art is used for identifying GUI elements.

For this purpose, the present invention involves two aspects as follows: generation of the enhanced identification information (i.e. a training phase), and identification of the GUI elements based on the enhanced identification information (i.e. a running phase). Hereinafter, these two aspects will be described respectively referring to the drawings.

It should be noted that in the following descriptions “XPath information” is illustrated as an example of “attribute information”. However, the “attribute information” is not limited to the “XPath information”, and may comprise descriptions of GUI elements in other languages besides XML. For example, information as described in any of programming languages such as C, Basic and Python, or non-programming languages such as Text may be used as the attribute information.

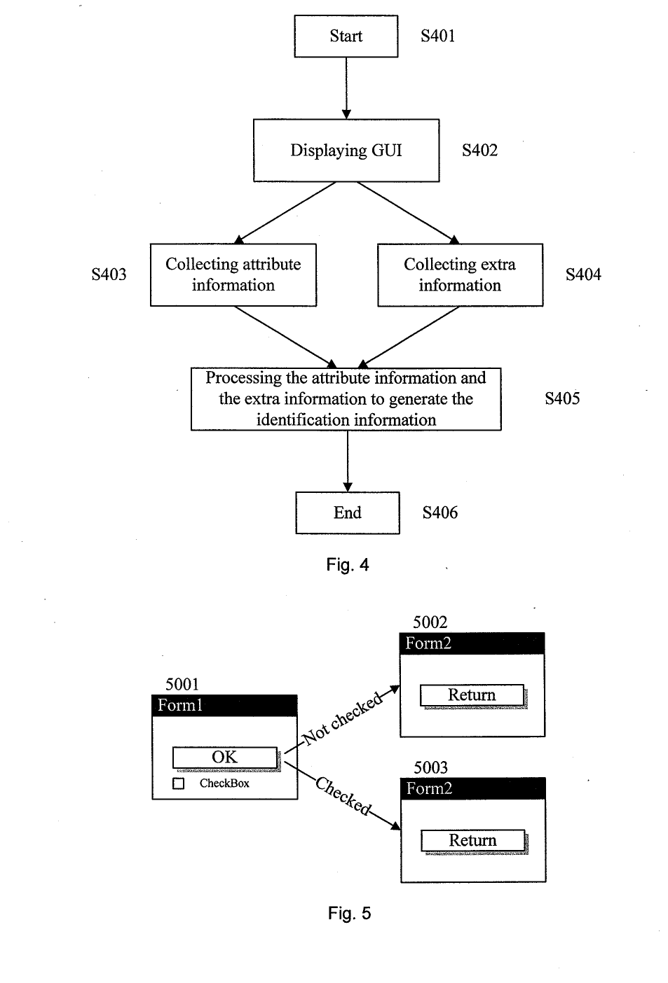

FIG. 4 shows a method of generating GUI element identification information according to an embodiment of the present invention. As illustrated in FIG. 4, the method starts in step S401. Next in step S402, a GUI is displayed by a display device such as a display monitor. The GUI comprises a target GUI element. Hereinafter, identification information will be generated for the target GUI element.

Then, attribute information of the target GUI element, e.g. XPath information, may be collected in step S403, and extra information, other than the attribute information, related to the target GUI element may be collected in step S404, respectively. Here, the steps S403 and S404 may be performed in parallel or sequentially. Then in step S405, the attribute information and the extra information collected for the target GUI element may be processed to generate enhanced identification information for the target GUI element. Here for example, the attribute information and the extra information may be combined to form the enhanced identification information. Finally, the method ends in step S406.

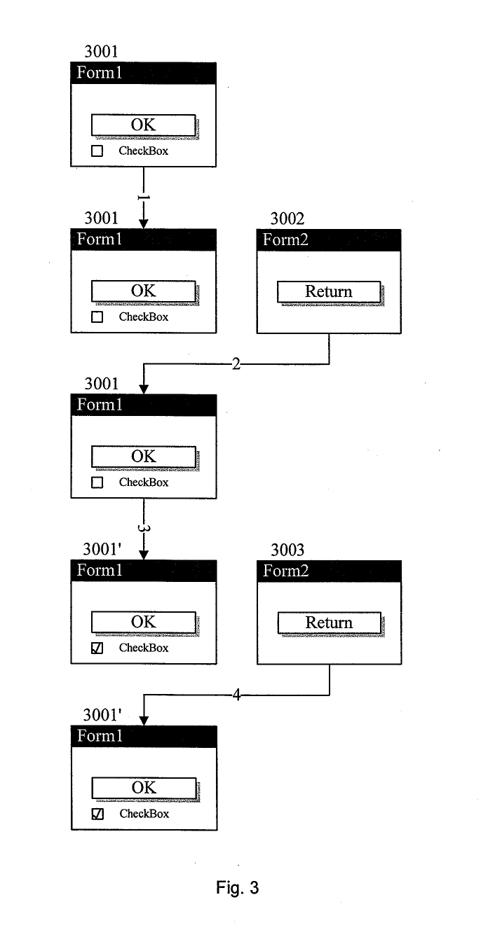

Hereinafter, the steps S403 and S404 will be described in detail with reference to an example illustrated in FIG. 5. The example shown in FIG. 5 corresponds to that shown in FIG. 3. In particular, when in a GUI element 5001 an “OK” key is clicked without checking a checkbox, a GUI element 5002 (target GUI element 1) will be popped up; while when in the GUI element 5001 the “OK” key is clicked with the checkbox checked, a GUI element 5003 (target GUI element 2) will be popped up. In connection with the above descriptions on FIG. 3, these two GUI elements 5002 and 5003 are not identical with each other.

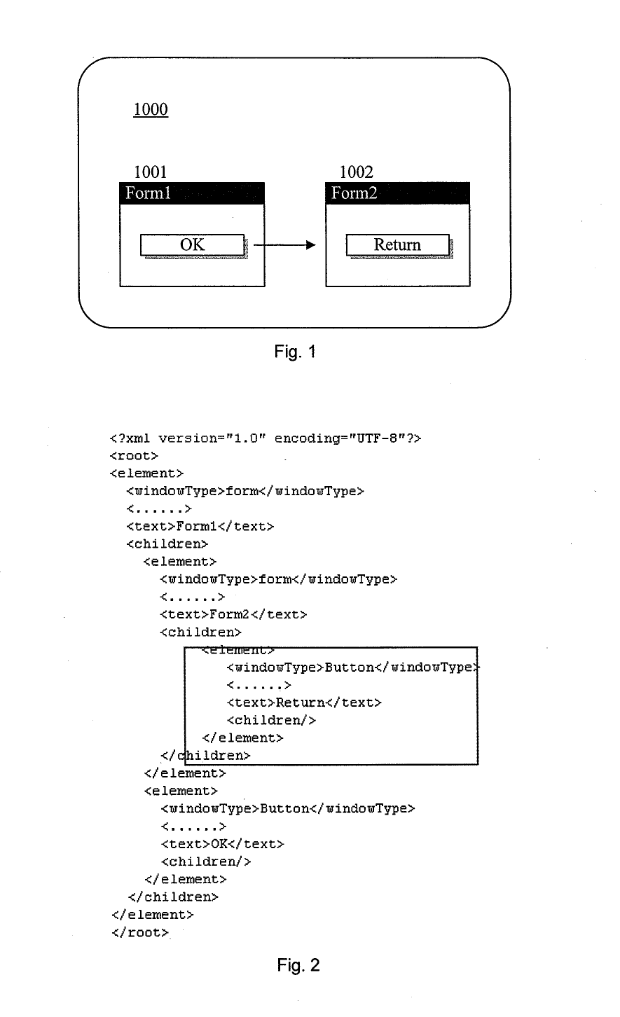

In the prior art, there are many approaches to acquire the attribute information of the GUI elements such as the XPath information. For example, in the step S403, information about all UI elements on the GUI (including the target GUI element 1 or 2) may be acquired, the information being formed in XML format. Finally, the UI element information in XML format, as shown in FIG. 2, is formed.

Then, the acquired UI element information in XML format may be analyzed to obtain the XPath information of the target GUI element. Here, as discussed in the description with reference to FIG. 3, the GUI elements 5002 and 5003 have the same GUI information as each other, i.e.,

“/element[@text=‘Form1’]/children/element[@text=‘Form2’]/children/
element[@text=‘Return’]”.

The characteristics of the present invention further consist in that the extra information related to the target GUI element may be acquired in step S404. For example, the “extra information” may comprise: information on historical event(s) resulting in occurrence of the target GUI element, e.g. operation events of a user by means of input devices such as keyboard and mouse; and/or system state information related to the target GUI element, e.g. occupied hardware (i.e. memory, CPU, etc.) resources or software resources (such as the number of GUI objects), and the like. In the following descriptions, the historical event information is taken as an example. However, it should be noted that the “extra information” in the present invention is not limited to such historical event information.

In step S404, in order to acquire the historical event information, the historical event(s) resulting in occurrence of the target GUI element may be recorded firstly. For example, the events which cause the occurrence of the target GUI element 1 (5002 in FIG. 5) comprise: clicking the “OK” key in the GUI element 5001; and not checking the checkbox (or clicking the checkbox even times). The events which may cause the occurrence of the target GUI element 2 (5003 in FIG. 5) comprise: clicking the “OK” key in the GUI element 5001; and checking the checkbox (or clicking the checkbox odd times).

After the historical event(s) resulting in the occurrence of the target GUI element has/have been recorded, the historical event(s) may be analyzed to obtain conditions under which the target GUI element will occur. Such analysis may be completed manually or by an automatic training program during the training phase. Here, for convenience of descriptions, the occurrence conditions for the respective GUI elements may be described in logic expressions as follows:

[Target GUI element 1]

Condition 1 (representing that the checkbox is not clicked at all):
(“/element[@text=‘Form1’]/children/element[@text=‘CheckBox’]
ButtonClick”) == False
OR Condition 2 (representing that the checkbox is clicked even times):
(“/element[@text=‘Form1’]/children/element[@text=‘CheckBox’]
ButtonClick”) % 2 == 0

[Target GUI element 2]

Condition 1 (representing that the checkbox is clicked):
(“/element[@text=‘Form1’]/children/element[@text=‘CheckBox’]
ButtonClick”) == True
AND Condition 2 (representing that the checkbox is clicked odd times):
(“/element[@text=‘Form1’]/children/element[@text=‘CheckBox’]
ButtonClick”) % 2 == 1

It should be noted that the above logic expressions are only given for convenience of the explanations. In practical applications, the occurrence conditions for the target GUI element may be described in various ways (for example, in form of tables). These occurrence conditions represent the historical event information which causes the occurrence of the target GUI element.

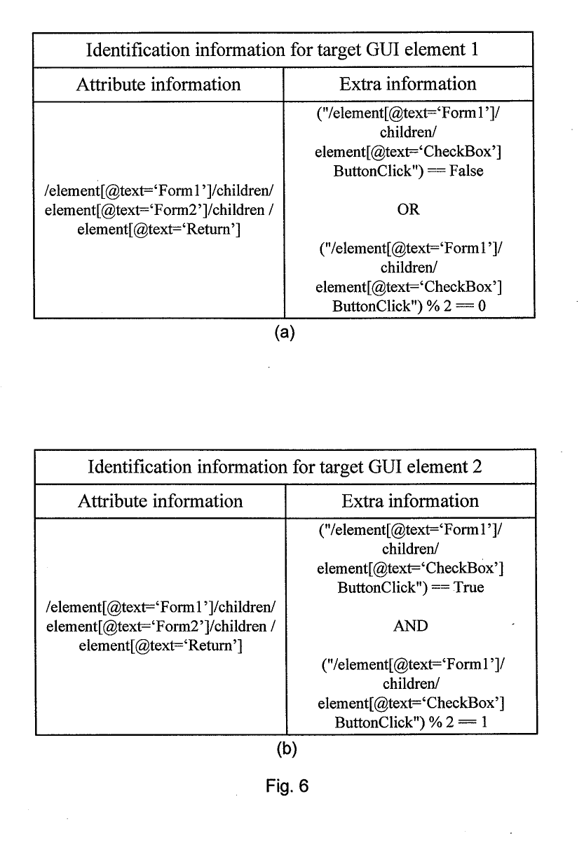

After the attribute information (here, the XPath information) and the extra information of the target GUI element are acquired as illustrated above, they are processed (e.g. combined) in step S405 to obtain the identification information for the target GUI element. For example, for the example shown in FIG. 5, the identification information for the target GUI element 1 (5002) and the target GUI element 2 (5003) may those illustrated in FIG. 6(a) and FIG. 6(b), respectively. It is to be noted that the identification information as shown in FIG. 6 is only illustrative, and other different forms of identification information are possible.

After the enhanced identification information of the GUI element is acquired during the training phase as described above, the GUI element may be identified with the enhanced identification information during the running phase.

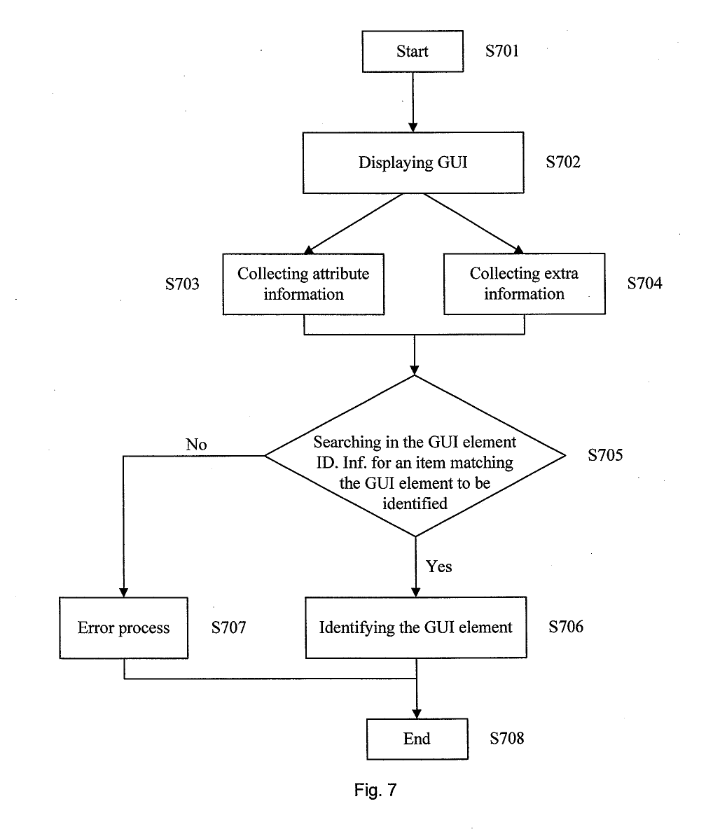

FIG. 7 shows a method of identifying a GUI element based on GUI element identification information according to an embodiment of the present invention. As shown in FIG. 7, the method starts in step S701. Firstly, in step S702, a GUI is displayed by a display device such as a display monitor. The GUI comprises the GUI element to be identified.

Then, attribute information, such as XPath information, of the GUI element to be identified may be collected in step S703, and extra information, other than the attribute information, related to the GUI element to be identified may be collected in step S704, respectively. The collections of the attribute information and the extra information are similar to those during the training phase, and thus detailed descriptions thereon are omitted here.

After the attribute information and the extra information for the GUI element to be identified are acquired, then in step S705, the GUI element identification information as recorded during the training phase is searched to find whether there is an item matching the acquired attribution information and extra information. If there is such a matching item, the GUI element to be identified is identified as one corresponding to the matching item in step S706. Otherwise, an error process, e.g. reporting to the user, may be performed in step S707. Finally, the method ends in step S708.

The above identification process will be described in detail in connection with the example as illustrated in FIG. 3. Here, also the XPath information and the historical event information are illustrated by way of example. However it should be noted that the present invention is not limited to such XPath information and historical event information.

In a case where the GUI element 3001 exists on the GUI currently displayed by the local application, if the “OK” key is directly clicked without clicking the checkbox (as shown by the arrow 1 of FIG. 3), the GUI element 3002 will occur on the GUI. The XPath information for the GUI element 3002 may be acquired as:

“/element[@text=‘Form1’]/children/element[@text=‘Form2’]/children/
element[@text=‘Return’]”.

At the same time, the event which causes the occurrence of the GUI element 3002 is:

“/element[@text=‘Form1’]/children/element[@text=‘OK’] ButtonClick”
(representing that the “OK” key is clicked).

The above acquired XPath information and historical event information for the GUI element 3002 may be compared with the identification information (as shown in FIGS. 6(a) and (b)) acquired during the training phase. Since the event which causes the occurrence of the GUI element 3002 is that the “OK” key is clicked, that is, the checkbox is not clicked, i.e.,

(“/element[@text=‘Form1’]/children/element[@text=‘CheckBox’]
ButtonClick”) == False.

Hence, it can be known from the comparison that the GUI element 3002 matches the identification information of the target GUI element 1 as illustrated in FIG. 6(a). Therefore, the GUI element 3002 may be identified as the target GUI element 1.

Similarly, in a case where the GUI element 3001 exists on the GUI currently displayed by the local application, if the checkbox is checked by being clicked once and then the “OK” key is clicked (as shown by the arrow 3 of FIG. 3), the GUI element 3003 will occur on the GUI. The XPath information for the GUI element 3003 may be acquired as:

“/element[@text=‘Form1’]/children/element[@text=‘Form2’]/children/
element[@text=‘Return’]”.

At the same time, the event which causes the occurrence of the GUI element 3003 is:

“/element[@text=‘Form1’]/children/element[@text=‘CheckBox’]
ButtonClick” (representing that the checkbox is clicked), and
“/element[@text=‘Form1’]/children/element[@text=‘OK’] ButtonClick”
(representing that the “OK” key is clicked).

The above acquired XPath information and historical event information for the GUI element 3003 may be compared with the identification information (as shown in FIGS. 6(a) and (b)) acquired during the training phase. Since the event which causes the occurrence of the GUI element 3003 is that the checkbox is clicked once, i.e.,

(“/element[@text=‘Form1’]/children/element[@text=‘CheckBox’]
ButtonClick”) == True, and
(“/element[@text=‘Form1’]/children/element[@text=‘CheckBox’]
ButtonClick”) % 2 == 1.

Hence, it can be known from the comparison that the GUI element 3003 matches the identification information of the target GUI element 2 as illustrated in FIG. 6(b). Therefore, the GUI element 3003 may be identified as the target GUI element 2.

In this way, the GUI elements 3002 and 3003 which would not be distinguished in the prior art may be differentiated by the method of the present invention.

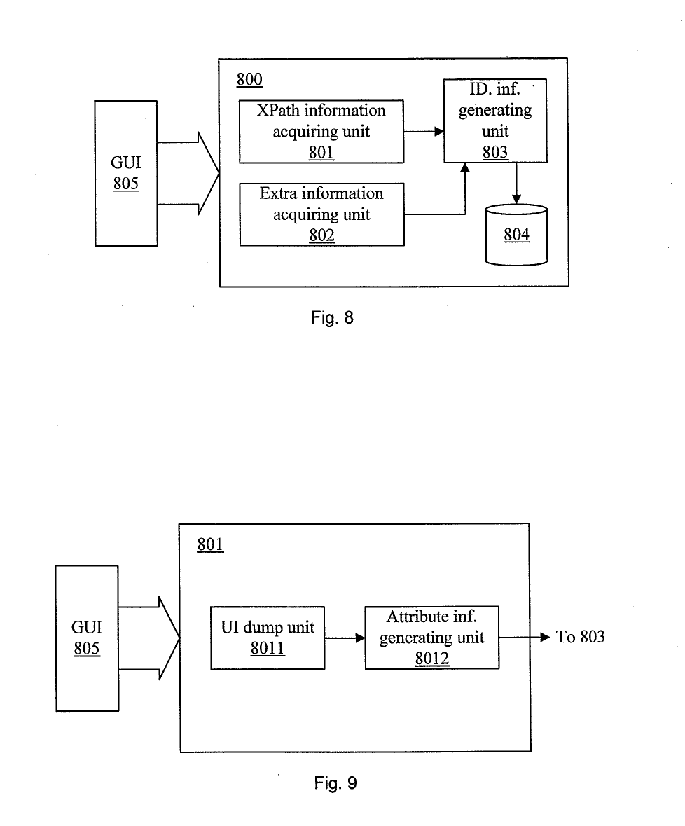

According to the present invention, there is further provided an apparatus of generating GUI element identification information. FIG. 8 shows a schematic diagram of the apparatus of generating the GUI element identification information according to an embodiment of the present invention. As shown in FIG. 8, the apparatus 800 of generating the GUI element identification information comprises a display device 805 adapted to display a GUI which includes a target GUI element. In the following, the identification information will be generated for the target GUI element. The apparatus 800 may further comprise: an attribute information acquiring unit 801 adapted to analyze the displayed GUI to acquire attribute information, such as XPath information, for the target GUI element; an extra information acquiring unit 802 adapted to acquire extra information related to the target GUI element, according to historical event(s), e.g., operations by the user through input devices such as keyboard and mouse, and/or system states and the like; and an identification information generating unit 803 adapted to process the attribute information acquired by the attribute information acquiring unit 801 and the extra information acquired by the extra information acquiring unit 802 to generate the identification information for the target GUI element.

The apparatus 800 may further comprise a storage device 804. For example, the storage device 804 may be used for storing the attribute information acquired by the attribute information acquiring unit 801, the extra information acquired by the extra information acquiring unit 802 and/or the identification information generated by the identification information generating unit 803 etc. The storage device 804 may be a memory inside the apparatus 800 of generating the identification information, or may be an external memory and even a network memory. The is storage device 804 may comprise a single memory, and may further comprise a plurality of memories.

FIG. 9 shows a schematic structure diagram of the attribute information acquiring unit 801 according to an embodiment of the present invention. As illustrated in FIG. 9, the attribute information acquiring unit 801 may comprise: a UI dump unit 8011 adapted to acquire UI element information, which is in XML format, from the displayed GUI; and an attribute information generating unit 8012 adapted to analyze the UI element information acquired by the UI dump unit 8011 to acquire the XPath information for the target GUI element.

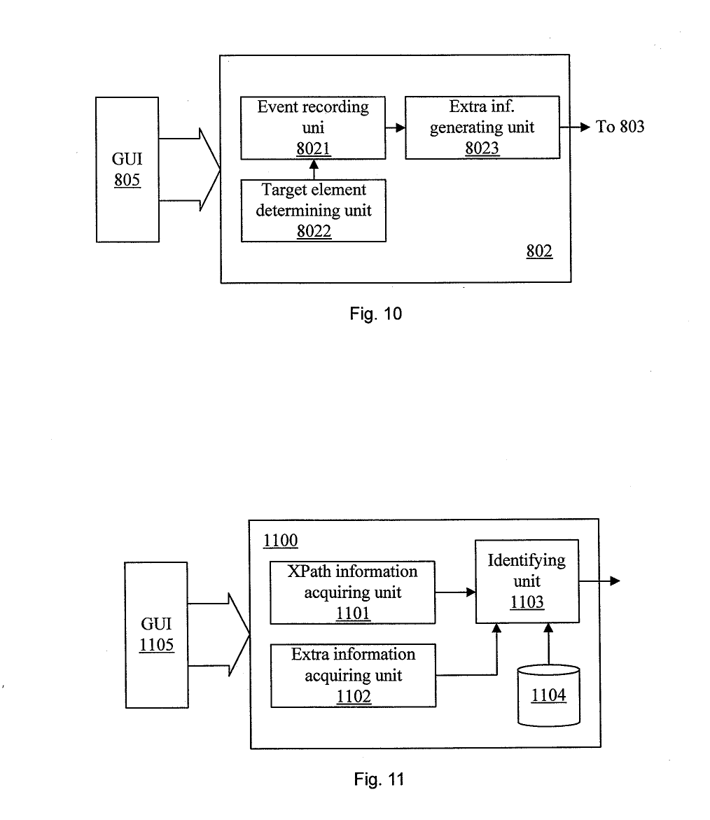

FIG. 10 shows a schematic structure diagram of the extra information acquiring unit 802 according to an embodiment of the present invention. As illustrated in FIG. 10, the extra information acquiring unit 802 may comprise: an event recording unit 8021 adapted to record historical events causing occurrence of the target GUI element, or system states related to the target GUI element, etc. (here being collectively referred to as “events”, the user may indicate in the system what kind of events, e.g. the historical events or the system states, to be recorded); a target GUI element determining unit 8022 adapted to determine whether the target GUI occurs on the displayed GUI or not, and to send the determination result to the event recording unit 8021; and an extra information generating unit 8023 adapted to generate the extra information based on the event(s) for the target GUI element recorded by the event recording unit 8021.

Here, it is to be noted that the element determining unit 8022 is required here to determine whether the target UGI element occurs or not. This is because it is still in the training phase when the identification information are being generated and thus there must be “someone” (or an automatic training program) to notify the computer of the occurrence of the target GUI element. After the identification information of the GUI element is acquired during the training phase, the GUI element may be identified automatically during the running phase.

Here, the element determining unit 8022 may notify the event recording unit 8021 of the determination result as illustrated above. Optionally, the element determining unit 8022 may notify the attribute information acquiring unit 801 (specifically, the attribute information generating unit 8012, for example) of the result so that the attribute information acquiring unit 801 may acquire the attribute information for the target GUI element correctly.

According to the present invention, there is further provided an apparatus of identifying a GUI element. FIG. 11 shows the apparatus of identifying a GUI element according to an embodiment of the present invention. As shown in FIG. 11, the apparatus 1100 of identifying a GUI element comprises: storage means 1104 adapted to store GUI element identification information, for example that acquired during the training phase; a display device 1105 adapted to display a GUI which includes the GUI element to be identified; an attribute information acquiring unit 1101 adapted to acquire the attribute information for the GUI element to be identified; an extra information acquiring unit 1102 adapted to acquire extra information related to the GUI element to be identified, such as historical events (e.g. operations such as key-pressing and clicking by a user through input devices such as mouse and keyboard), system states, and the like; and an identifying unit 1103 adapted to identify the GUI element to be identified based on the attribute information acquired by the attribute information acquiring unit 1101 and the extra information acquired by the extra information acquiring unit 1102 as well as the GUI element identification information stored in the storage means 1104.

Here, the GUI element identification information is stored in the storage means 1104. For example, the information may be acquired by performing the method as illustrated in FIG. 4, or may be generated by the apparatus 800 of generating the identification information as shown in FIG. 8. The storage means 1104 may be storage means inside the apparatus 1100 of identifying the GUI element, or storage means external to the apparatus 1100 of identifying the GUI element, such as a network memory.

Further, the attribute information acquiring unit 1101 comprised in the apparatus 1100 of identifying the GUI element may have the same structure as the attribute information acquiring unit 801 comprised in the apparatus 800 of generating the GUI element identification information as described above. Also, the extra information acquiring unit 1102 comprised in the apparatus 1100 of identifying the GUI element may have a structure similar to the extra information acquiring unit 1102 comprised in the apparatus 800 of generating the GUI element identification information as described above, except that the target GUI element determining unit 8022 is not needed.

According to the present invention, there is further provided a GUI element identification system, comprising the above apparatus of generating GUI element identification information and the GUI element identifying apparatus according to the present invention. In the system, the generation of the GUI element identification information (the training phase) and the identification of the GUI element (the running phase) may be completed. In this system, the apparatus of generating the GUI element identification information and the GUI element identifying apparatus may be separated devices (e.g., two independent devices connected via the network). Or alternatively, the apparatus of generating the GUI element identification information and the GUI element identifying apparatus may be integrated into a single entity. Specifically, the respective attribute information acquiring units (801, 1101), extra information acquiring units (802, 1102) in the apparatus of generating the GUI element identification information and the GUI element identifying apparatus may be constituted by one same unit, or may be formed as separated units. The GUI element identification information generated by the apparatus of generating the GUI element identification information may be stored in the storage means of the GUI element identifying apparatus.

The present invention is illustrated in the above with reference to the embodiments thereof. However, those embodiments are just provided for illustrative purpose, and are not intended to limit the present invention. The scope of the present invention is defined by the following claims as well as equivalents thereof. Therefore, those skilled in the art can make various modifications and substitutions and thereto without departing from the scope of the present invention, which all fall into the scope of the present invention.

What is claimed is:

1. A method of generating Graphical User Interface (GUI) element identification information, comprising:
displaying a GUI which includes a target GUI element;
analyzing the displayed GUI, to acquire attribute information for the target GUI element;
acquiring extra information, other than the attribute information, related to the target GUI element; and
processing the attribute information and the extra information to generate the identification information for the target GUI element.

2. The method according to claim 1, wherein the attribute information comprises XPath information, and acquiring the attribute information comprises:
acquiring information, which is in XML format, on all elements within the GUI; and
analyzing the element information in XML format to acquire the XPath information for the target GUI element.

3. The method according to claim 1, wherein the extra information comprises information on historical event(s) causing the target GUI element to occur, and acquiring the extra information comprises:
recording the historical event(s) causing the target GUI element to occur; and
analyzing the historical event(s) to transform it/them into occurring condition(s) for the target GUI element,
wherein the occurring condition(s) become(s) the information on historical event(s) for the target GUI element.

4. The method according to claim 1, wherein the extra information comprises system state information.

5. A method of identifying a Graphical User Interface (GUI) element to be identified based on GUI element identification information, the GUI element identification information comprising attribute information and extra information for respective GUI element(s), the method comprising:
displaying a GUI which includes the GUI element to be identified;
analyzing the displayed GUI, to acquire attribute information for the GUI element to be identified;
acquiring extra information, other than the attribute information, related to the GUI element to be identified; and
searching the GUI element identification information for an information item with attribute information matching the acquired attribute information for the GUI element to be identified and also with extra information matching the acquired extra information related to the GUI element to be identified.

6. The method according to claim 5, wherein the extra information comprises historical event information and/or system state information.

7. An apparatus for Graphical User Interface (GUI) element identification, comprising a display device adapted to display a GUI which includes a target GUI element and a device of generating GUI element identification information, the device of generating GUI element information comprising:
an attribute information acquiring unit adapted to analyze the displayed GUI to acquire attribute information for the target GUI element;
an extra information acquiring unit adapted to acquire extra information, other than the attribute information, related to the target GUI element; and
an identification information generating unit adapted to process the attribute information acquired by the attribute information acquiring unit and the extra information acquired by the extra information acquiring unit to generate the identification information for the target GUI element.

8. The apparatus according to claim 7, wherein the attribute information comprises XPath information, and the attribute information acquiring unit comprises:
an UI dump unit adapted to acquire information, which is in XML format, on all elements within the GUI; and
an attribute information generating unit adapted to analyze the element information in XML format acquired by the UI dump unit to acquire the XPath information for the target GUI element.

9. The apparatus according to claim 7, wherein the extra information comprises information on historical event(s) causing the target GUI element to occur, and the extra information acquiring unit comprises:
an event recording unit adapted to record the historical event(s) causing the target GUI element to occur;
a target GUI element determining unit adapted to determine whether the target GUI occurs on the GUI or not, and to send the determination result to the event recording unit; and
an extra information generating unit adapted to generate the extra information comprising the information on the historical event(s) based on the historical event(s) for the target GUI element recorded by the event recording unit.

10. The apparatus according to claim 7, further comprising a device of identifying a GUI element, wherein the display device displays a GUI which includes the GUI element to be identified, the device of identifying the GUI element comprising:
storage means adapted to store the GUI element identification information comprising attribute information and extra information for respective GUI element(s);
an attribute information acquiring unit adapted to analyze the displayed GUI to acquire attribute information for the GUI element to be identified;
an extra information acquiring unit adapted to acquire extra information, other than the attribute information, related to the GUI element to be identified; and
an identifying unit adapted to identify the GUI element to be identified based on the attribute information acquired by the attribute information acquiring unit and the extra information acquired by the extra information acquiring unit as well as the GUI element identification information stored in the storage means.

11. The apparatus according to claim 10, wherein
the attribute information acquiring unit included in the device of generating GUI element identification information and the attribute information acquiring unit included in the GUI element identifying device are made by a same unit, and
the extra information acquiring unit included in the apparatus of generating GUI element identification information and the extra information acquiring unit included in the GUI element identifying apparatus are made by a same unit.
